(19) United States
(12) Patent Application Publication
(10) Pub. No.: US 2022/0348282 A1
(43) Pub. Date: Nov. 3, 2022

(54) BICYCLE ACCESSORY

(71) Applicant: Corey Drew Ryckman, Chilliwack (CA)

(72) Inventor: Corey Drew Ryckman, Chilliwack (CA)

(21) Appl. No.: 17/243,521

(22) Filed: Apr. 28, 2021

(51) Int. Cl. B62J 50/00; B62J 27/30

(52) U.S. Cl. CPC B62J 50/00; B62J 27/30

(57) ABSTRACT

A bicycle accessory that is configured to be operably coupled to a first bicycle proximate the rear thereof wherein the bicycle accessory is further configured to be operably engaged by a second bicycle located rearward of the first bicycle so that the second bicycle can assist in the forward propulsion of the first bicycle. The present invention includes a frame wherein the frame includes a first support member and a second support member. The first support member and the second support member each have impact reduction members formed as a part thereof. The frame includes a rear engagement assembly wherein the rear engagement assembly includes mounting plates having an upper roller member and a lower roller member secured therebetween. The upper roller member and lower roller member are rotatably mounted and configured to engage a front tire of the second bicycle.

### FIELD OF THE INVENTION

The present invention relates generally to bicycle accessories, more specifically but not by way of limitation, an apparatus configured to be operably coupled to a first bike wherein the apparatus accommodates engagement from a second bike wherein the second bike can assist in the propulsion of the first bike.

### BACKGROUND

Millions of people regularly ride bicycles either for urban commuting, recreation or as a source of physical exercise. There are numerous different styles of bicycles available and they are built to accommodate a particular type of rider as well as be utilized for various types of terrain. By way of example but not limitation, bicycle styles range from mountain bikes, street bicycles and recumbent bicycles. All of the aforementioned are utilized to traverse various different types of terrain and by different riders. It is very common for young children to ride bicycles as part of a normal outdoor recreational play routine. Children will typically ride smaller bicycles and when learning can further include training wheels. As small children begin to initiate their ability to ride a bicycle their muscle development will take time to mature in order to begin to ride the bicycle more effectively and for longer periods of times.

Many times parents will ride bicycles with their children. As parent ride along with their children it will occur fairly often that the child may need help in propulsion of the bicycle. Either the child has become tired or perhaps terrain changes such as but not limited to a hill can result in a child's inability to continue to pedal the bicycle so as to provide the proper amount of propulsion to keep the bicycle moving forward. This can be challenging for a parent to assist the child as it often requires the parent to dismount their own bicycle which is very inconvenient.

Accordingly, there is a need for an apparatus that can be operably coupled to a first bicycle wherein the apparatus is configured to be engaged by a second bicycle wherein the rider of the second bicycle can assist in the forward movement of the first bicycle.

### SUMMARY OF THE INVENTION

It is the object of the present invention to provide an apparatus that is configured to be operably coupled to a bicycle wherein the apparatus facilitates forward propulsion assistance from a second bicycle wherein the present invention includes a frame configured to be coupled to the rear sprocket area of the first bicycle.

Another object of the present invention is to provide a bicycle accessory configured to be secured to a child's bicycle in order to provide a technique to assist in the forward propulsion thereof wherein the frame includes a first support member and a second support member.

A further object of the present invention is to provide an apparatus that is configured to be operably coupled to a bicycle wherein the apparatus facilitates forward propulsion assistance from a second bicycle wherein the first support member includes an impact reduction member operably coupled therewith.

Still another object of the present invention is to provide a bicycle accessory configured to be secured to a child's bicycle in order to provide a technique to assist in the forward propulsion thereof wherein the second support member includes an impact reduction member.

An additional object of the present invention is to provide an apparatus that is configured to be operably coupled to a bicycle wherein the apparatus facilitates forward propulsion assistance from a second bicycle wherein the present invention further includes a rear engagement assembly.

Yet a further object of the present invention is to provide a bicycle accessory configured to be secured to a child's bicycle in order to provide a technique to assist in the forward propulsion thereof wherein the rear engagement assembly is secured to the first support member and the second support member distal to the rear sprocket area of the bicycle to which the present invention is secured.

Another object of the present invention is to provide an apparatus that is configured to be operably coupled to a bicycle wherein the apparatus facilitates forward propulsion assistance from a second bicycle wherein the rear engagement assembly further includes a first roller member and a second roller member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side diagrammatic view of the present invention; and

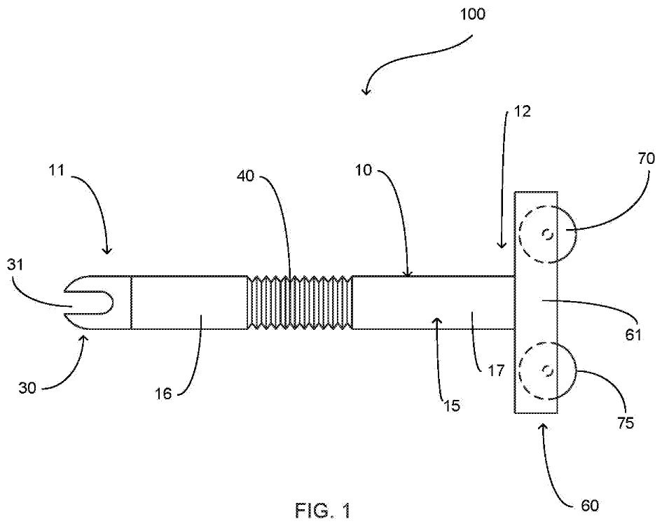

FIG. 2 is a rear perspective view of an embodiment of the present invention operably coupled to a bicycle.

### DETAILED DESCRIPTION

Referring now to the drawings submitted herewith, wherein various elements depicted therein are not necessarily drawn to scale and wherein through the views and figures like elements are referenced with identical reference numerals, there is illustrated a bicycle accessory 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the bicycle accessory 100 includes a frame 10. The frame 10 is configured to be secured to a bicycle 99 proximate the rear sprocket thereof. The frame 10 is manufactured from a lightweight rigid material such as but not limited to aluminum. The frame 10 includes a first end 11 and a second end 12 wherein the first end 11 is secured to the bicycle 99 and the second end 12 is distally located thereto. Subsequent being secured to the bicycle 99 the frame 10 is in a generally horizontal position in order to be engaged by a second bicycle(not illustrated herein) that is in a rearward location within respect to the bicycle 99 as will be further discussed herein.

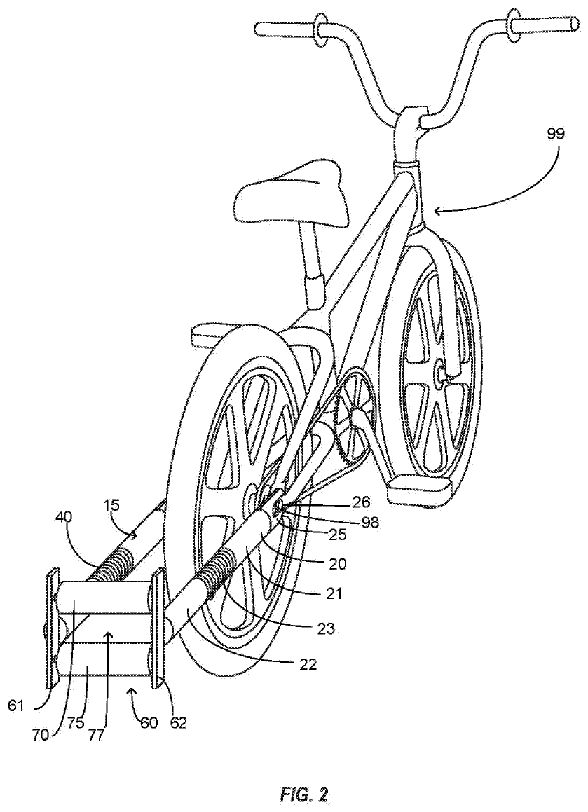

The frame 10 includes a first support member 15 and a second support member 20. The first support member 15 is manufactured from a suitable material such as but not limited to aluminum tubing. The first support member 15 includes and first section 16 and a second section 17. Contiguously formed on the first section 16 proximate the first end 11 is coupler 30. The coupler 30 includes a channel 31 formed therein. Coupler 30 is configured to be operably coupled to the bolt axle of a conventional bicycle 99. The channel 31 includes opening 32 so as to be operably coupled to the bolt axle of the bicycle 99 wherein the channel 31 has the bolt axle placed thereinto and is subsequently tightened with nut 98 on the bicycle so as to secure the frame 10 in the desired position illustrated in FIG. 2 herein. While the frame 10 is illustrated as being secured to the bolt axle/rear sprocket area of the bicycle, it is contemplated within the scope of the present invention that the frame 10 could be configured to be releasably secured to alternate areas on the bicycle 99 and still achieve the desired function as described herein.

Intermediate the first section 16 and second section 17 is the impact reduction member 40. The impact reduction member 40 is operable to absorb at least most of the force that the frame 10 is subjected to when the frame 10 is impacted by a second bicycle rearward of the bicycle 99. The impact reduction member 40 provides a cushioning between the second section 17 as it compresses towards the first section 16 when a force is applied to the rear engagement assembly 60. This absorption of force allows for minimal disruption to the bicycle 99 so as to ensure no loss of control thereof by the rider. It is contemplated within the scope of the present invention that various elements could be utilized to construct the impact reduction member 40 such as but not limited to springs or hydraulics.

The frame 10 includes the second support member 20, which is identically constructed as the first support member 15. The second support member 20 includes a first section 21, a second section 22 and an impact reduction member 23 intermediate thereto. All of the aforementioned are identical as described herein for the first support member 15. Additionally the second support member 20 includes an identical coupler 25 and channel 26 as described herein for the first support member 15. While a preferred embodiment of the frame 10 has been illustrated herein, it is contemplated within the scope of the present invention that the frame 10 could be constructed in alternate manners and achieve the desired objective discussed herein.

Secured to the second end 12 of the frame 10 is the rear engagement assembly 60. The rear engagement assembly 60 provides the interface for a second bicycle to provide a forward motion force so as to assist in the propulsion of the bicycle 99. In the preferred technique of use, a rider on a second bicycle will place their front tire such that the front tire is engaged with the rear engagement assembly 60 and as such propulsion of the second bicycle located rearward of the bicycle 99 will result in forward motion of the bicycle 99. The rear engagement assembly 60 includes a first mounting plate 61 and a second mounting plate 62. The first mounting plate 61 and second mounting plate 62 are secured to the first support member 15 and second support member 20 respectively utilizing suitable techniques. The first mounting plate 61 and second mounting plate 62 are manufactured from metal plate or other suitable rigid material. First mounting plate 61 and second mounting plate 62 are parallel to each other and vertical in orientation. It is contemplated within the scope of the present invention that the rear engagement assembly 60 could be pivotally mounted so as to be movable in an upwards-downwards motion to ensure engagement with a front bicycle tire of a second bicycle pushing the bicycle 99.

An upper roller member 70 and a lower roller member 75 are movably secured intermediate the first mounting plate 61 and second mounting plate 62. The upper roller member 70 and lower roller member 75 are horizontal in orientation and perpendicular to the first mounting plate 61 and second mounting plate 62. The upper roller member 70 and lower roller member 75 are movably secured to the first mounting plate 61 and second mounting plate 62 so as to provide rotational movement of the upper roller member 70 and lower roller member 75. The rotational movement of the upper roller member 70 and lower roller member 75 provides a transfer of motion between a rolling front tire of a second bicycle rearward of the bicycle 99 engaged therewith. The upper roller member 70 and lower roller member 75 inhibit any disruption to the rolling motion of the front tire of the second bicycle. A void 77 is present intermediate the upper roller member 70 and lower roller member 75 which assists in the engagement of the front tire of the second bicycle present rearward of the bicycle 99. While an upper roller member 70 and lower roller member 75 have been illustrated and discussed herein in the preferred embodiment of the present invention, it is contemplated within the scope of the present invention that the rear engagement assembly 60 could have only one roller member and still achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A bicycle accessory configured to be mounted to a first bicycle and operably engaged with a second bicycle located rearward of the first bicycle wherein the bicycle accessory comprises:
a frame, said frame having a first end and a second end, said first end being secured to said first bicycle, said second end being distal to said first end, said frame extending outward from said first bicycle in a rearward direction; and
a rear engagement assembly, said rear engagement assembly configured to have at least one rotatable member, said rear engagement assembly being secured to said second end of said frame, said rear engagement assembly operable to engage a front tire of the second bicycle.

2. The bicycle accessory configured to be mounted to the first bicycle as recited in claim 1, wherein the frame further includes a first support member, said first support member having a first section and a second section.

3. The bicycle accessory configured to be mounted to the first bicycle as recited in claim 2, wherein said first support member further includes an impact reduction member, said impact reduction member being intermediate said first section and said second section.

4. The bicycle accessory configured to be mounted to the first bicycle as recited in claim 3, wherein the frame further includes a second support member, said second support member having a first section and a second section, said second support member being parallel with said first support member and having a void therebetween.

5. The bicycle accessory configured to be mounted to the first bicycle as recited in claim 4, wherein said second support member further includes an impact reduction member, said impact reduction member of said second support member being intermediate said first section and said second section of said second support member.

6. The bicycle accessory configured to be mounted to the first bicycle as recited in claim 5, wherein said rear engagement assembly includes a first mounting plate and a second mounting plate, said first mounting plate and said second mounting plate having the at least one rotatable member mounted therebetween.

7. A bicycle accessory configured to be mounted to a first bicycle so as to be operably engaged with a second bicycle located rearward of the first bicycle wherein forward motion of the second bicycle is transferred to the first bicycle so as to assist in propulsion of the first bicycle wherein the bicycle accessory comprises:
a frame, said frame having a first end and a second end, said first end being secured to said first bicycle, said second end being distal to said first end, said frame extending outward from said first bicycle in a rearward direction, said frame further including a first support member, said first support member having a first section and a second section, said frame further includes a second support member, said second support member having a first section and a second section, said second support member being parallel with said first support member and having a void therebetween;
a rear engagement assembly, said rear engagement assembly being secured to said second end of said frame, said rear engagement assembly having first mounting plate and a second mounting plate, said first mounting plate and said second mounting plate having a void therebetween, said rear engagement assembly having an upper roller member and a lower roller member, said upper roller member and said lower roller member being rotatably mounted intermediate said first mounting plate and said second mounting plate, said rear engagement assembly operable to engage a front tire of the second bicycle.

8. The bicycle accessory configured to be mounted to the first bicycle as recited in claim 7, wherein said first support member further includes an impact reduction member, said impact reduction member being intermediate said first section and said second section, said impact reduction member configured to absorb force received to said rear engagement assembly.

9. The bicycle accessory configured to be mounted to the first bicycle as recited in claim 8, wherein said second support member further includes an impact reduction member, said impact reduction member of said second support member being intermediate said first section and said second section of said second support member said impact reduction member of said second support member configured to absorb force received to said rear engagement assembly.

10. The bicycle accessory configured to be mounted to the first bicycle as recited in claim 9, wherein said first end of said frame includes a coupler, said coupler having a channel configured to be secured to an axle bolt of the first bicycle.

11. The bicycle accessory configured to be mounted to the first bicycle as recited in claim 10, wherein the upper roller member and lower roller member have a void therebetween.

12. The bicycle accessory configured to be mounted to the first bicycle as recited in claim 11, wherein the upper roller member and lower roller member are perpendicular to the first mounting plate and second mounting plate.
